(19) United States
(12) Patent Application Publication
(10) Pub. No.: US 2007/0232721 A1
(43) Pub. Date: Oct. 4, 2007

(54) Water-Based Ink For Ink-Jet Recording

(75) Inventors: Akihiko Taniguchi, Ichinomiya-shi (JP); Yasuhiro Taga, Nagoya-shi (JP); Akira Endo, Obu-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Aichi-ken (JP)

(21) Appl. No.: 11/685,894

(22) Filed: Mar. 14, 2007

(30) Foreign Application Priority Data
Mar. 28, 2006 (JP) 2006-87562

(51) Int. Cl. C09D 11/00

(52) U.S. Cl. 523/160; 523/161

(57) ABSTRACT

A water-based ink for ink-jet recording may include a benzotriazole type compound for preventing corrosion of a metal in an ink ejection portion of an ink-jet head, and a coloring agent having a divalent metal in a structure thereof, and a polymer containing a polymerization unit having at least two carboxyl groups in an ethylene chain unit. The generation of a precipitate by reaction between the divalent metal and the benzotriazole type compound may be suppressed without using a sequestering agent. The ink may have an excellent corrosion inhibiting effect and an ink ejection stability effect.

### CROSS REFERENCE TO RELATED APPLICATION

This application claims priority to Japanese Patent Application No. 2006-87562, filed Mar. 28, 2006, which is incorporated herein by reference.

### BACKGROUND

An ink-jet recording apparatus has an ink-jet head with an ink ejection portion that ejects fine ink droplets of a water-based ink on a recording material. Several different systems can be used for ink ejection, such as an electrostatic attraction system, a drop-on-demand system, or a thermal ink-jet system. The ink ejection portion often has thin sheets of nickel or an iron-nickel alloy stacked one on top of another in a lamination structure. When the metal is continuously in contact with the water-based ink for ink-jet recording, corrosion can be generated in the metal. Metal rust powder resulting from the corrosion can be scattered in the ink, which can lead to ink ejection failure due to, for example, clogging of a nozzle. To avoid this problem, a benzotriazole type compound, specifically 1,2,3-benzotriazole, has been added to the ink as an anticorrosive (see U.S. Pat. Nos. 6,648,463 and 6,938,999).

Coloring agents having a divalent metal, for example a phthalocyanine type dye and the like, are widely used in water-based inks for ink-jet recording. A benzotriazole type compound often is added as an anticorrosive to inks having such coloring agents. Although generation of rust can be suppressed, the divalent metal contained in the coloring agent and the benzotriazole type compound can react with each other such that a precipitate is generated. For controlling the amount of a metal ion such as a calcium ion, a copper ion, a magnesium ion, or an iron ion, a sequestering agent such as ethylene diamine tetraacetic acid has been added to the ink (see U.S. Pat. No. 6,514,330).

As described in U.S. Pat. No. 6,514,330, the sequestering agent is effective for suppressing the generation of a precipitate by reaction between the coloring agent and the benzotriazole type compound. However, the sequestering agent can promote elution of an adhesive between adjacent layers of a lamination structure in an ink ejection portion of the ink-jet head, thereby decreasing the bonding strength of the lamination structure. Therefore, it would be desirable to avoid the need for using a sequestering agent when an ink ejection portion of the ink-jet head contains a metal member in a lamination structure.

### SUMMARY

In one aspect, a water-based ink for ink-jet recording has a coloring agent containing a divalent metal in a structure thereof, a benzotriazole type compound, and a polymer containing a polymerization unit having at least two carboxyl groups in an ethylene chain unit.

In another aspect, an ink-jet recording apparatus may be configured to have an ink cartridge filled with the above-described water-based ink for ink-jet recording. An ink-jet head contains an ink ejection portion which communicates with the ink cartridge. The ink ejection portion contains a metal member made of nickel or a nickel-containing alloy.

### BRIEF DESCRIPTION OF THE DRAWINGS

FIG. 1 shows a schematic perspective view of a configuration of an ink-jet recording apparatus; and

FIG. 2 shows a schematic view of an anodic polarization measurement.

### DETAILED DESCRIPTION

General Overview

In one aspect, a water-based ink for ink-jet recording includes a coloring agent having a divalent metal in a structure thereof, a benzotriazole type compound, and a polymer containing a polymerization unit (repeating unit) having at least two carboxyl groups in an ethylene chain unit. The benzotriazole type compound may prevent corrosion of a metal in an ink ejection portion of an ink-jet head. The polymer may be effective for suppressing generation of a precipitate by reaction between the divalent metal and the benzotriazole type compound without using a sequestering agent. The ink may have an excellent corrosion inhibiting effect and an ink ejection stability effect.

The ink provides both a corrosion inhibiting effect and an ink ejection stability effect. Although the ink contains a coloring agent having a divalent metal in the structure thereof and a benzotriazole type compound, generation of a precipitate by reaction between the divalent metal and the benzotriazole type compound may be effectively prevented. As a result, a corrosion inhibiting effect against the ink ejection portion of the ink-jet head may be accomplished while ink ejection failure may be suppressed to a great extent.

Illustrative Aspects of the Invention

A water-based ink for ink-jet recording (hereinafter sometimes “ink”) according to aspects of the invention includes a coloring agent containing a divalent metal in a structure thereof, a benzotriazole type compound, and a polymer containing a polymerization unit having at least two carboxyl groups in an ethylene chain unit. The ink also typically includes water and, optionally, water-soluble organic solvents as a humectant and/or a penetrant.

The polymer may prevent generation of a precipitate from the reaction between the divalent metal in the coloring agent and the benzotriazole type compound. Although not wanting to be bound by theory, it is believed that the polymer becomes a polymer ion having a multivalent negative charge in the ink. In particular, each of the carboxyl groups of the polymer becomes a carboxylato (multivalent minus polymer ion) negatively charged, to thereby form a strong negative electric field. It is believed that the thus-formed electric field strongly attracts the divalent metal, which has a positive charge, and interferes with a chemical reaction between the divalent metal and the benzotriazole type compound.

It is believed that the polymer does not form a chelate ring against the divalent metal in the ink. Although forming a chelate ring having a 5- or 6-member ring structure may be favorable from the standpoint of energy, a chelate ring having a 7-member ring structure is generally disadvantageous from the standpoint of energy. When a sodium salt of a carboxyl group of the polymer chelates the divalent metal, the carboxylato which is hydrophilic decreases in amount, and the water-solubility thereof is decreased. As a result, a precipitate may form.

In the polymer, the number of the carboxyl groups per ethylene chain unit is usually two or more, and often is two. When the number of carboxyl group is 1, the strength to attract the divalent metal is electrically not sufficient. Even when the divalent metal is attracted, free hydrophilic carboxylato becomes small in amount. Therefore, water solubility of the polymer tends to decrease. The reason why the polymer is used instead of a compound containing a low-molecular carboxyl group, such as ethylene diamine tetraacetic acid, is that problems associated with decreasing bonding strength of the lamination structure of the ink ejection portion of the ink-jet head may be avoided.

For purposes of suppressing the generation of the precipitate derived from the reaction between the divalent metal and the benzotriazole type compound, at least about 75% of the polymer unit configuring the polymer should be the polymer unit having at least two carboxyl groups in the ethylene chain unit. Up to 100% of the polymer units may be the polymer unit having at least two carboxyl groups in the ethylene chain unit.

Examples of compounds (monomers) which may be the polymerization unit (repeating unit) having at least two carboxyl groups in the ethylene chain unit include maleic acid, fumaric acid, itaconic acid, citraconic acid, mesaconic acid, sodium salts of these acids, and the like. A copolymer may include two or more of these compounds. Of these, itaconic acid and sodium itaconate each have a localized and strong negative charge. These monomers may be used to prepare polymers of polyitaconic acid and sodium polyitaconate. In addition to the monomers mentioned, other monomers such as acrylic acid, and methacrylic acid, may be used within the range of not impairing the effect of the polymer.

When the molecular weight of the polymer is unduly small, it may be necessary to increase the amount thereof to where ink ejection properties may be adversely affected. When the molecular weight is unduly high, the viscosity of the ink may increase undesirably. Given these considerations, the weight-average molecular weight is usually from about 5000 to about 15000, and often from about 6000 to about 9000.

The amount of the polymer in the ink usually ranges from a minimum amount below which the effect of preventing precipitation is not achieved, to a maximum amount above which the viscosity of the ink is increased and ink ejection stability may be decreased. Given these considerations, the amount of polymer usually ranges from about 0.05 wt % to about 5 wt %, and often from about 0.1 wt % to about 4 wt %, based on the total weight of the ink.

The ink includes one or more coloring agents having a divalent metal in the structure thereof. Non-limiting examples of coloring agents include dyes such as direct dyes, acid dyes, basic dyes, and the like, and pigments such as dispersant-using type pigments, self-dispersing type pigments, and the like. When the amount of coloring agent(s) in the ink is unduly small, a desired print density may not be achieved. When the amount of coloring agent(s) is unduly large, a precipitate may be generated when the ink is dried that may cause clogging of a nozzle or the like. Given these considerations, the amount of coloring agent usually ranges from about 0.2 wt % to about 10 wt %, and often from about 0.3 wt % to about 5 wt %, based on the total weight of the ink.

The divalent metals in the coloring agents may be, for example, copper, nickel, chromium, and the like. Examples of the coloring agents having a divalent metal in the structure thereof include, but are not limited to, complex type dyes such as metal phthalocyanine type dyes, monoazo complex type dyes and the like. In particular, copper complex dyes, particularly, copper phthalocyanine type dyes may be used.

Specific examples of the copper phthalocyanine type dyes include compounds represented by the following chemical formulas (1) to (5). In the chemical formulas (1) to (5), Pc (Cu) represents a copper phthalocyanine nucleus represented by the general formula (1), and at least one of R₁, R₂, R₃, and R₄ is presented in each of four benzene rings A, B, C, and D in the copper phthalocyanine nucleus represented by the general formula (1):

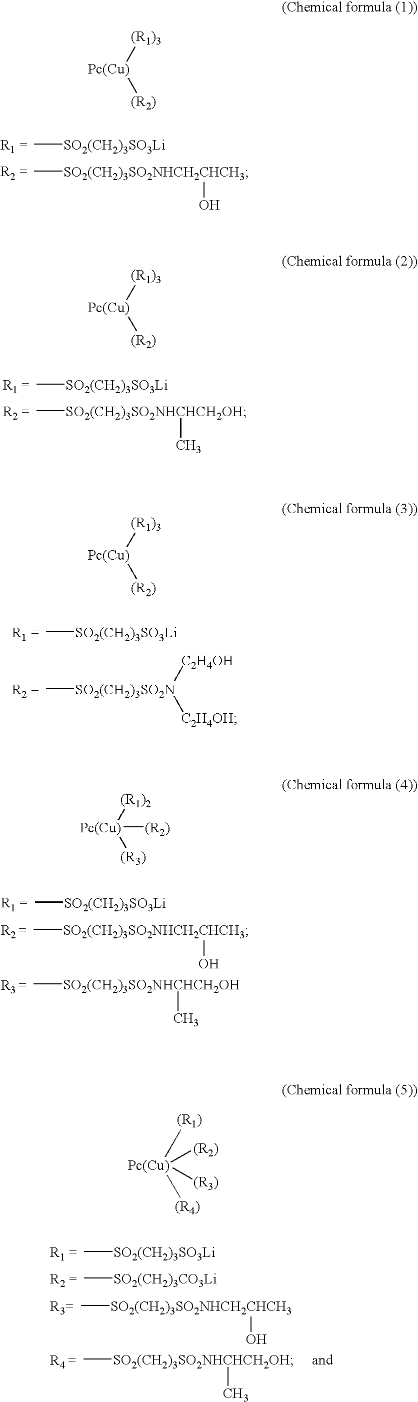

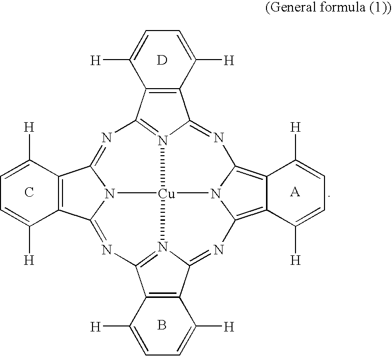

The ink also includes water. Water of high purity usually is used, such as deionized water, distilled water, or the like. The amount of water usually ranges from about 10 wt % to 98 wt %, and often from about 30 wt % to about 95 wt %, based on the total weight of the ink.

The ink according to aspects of the invention may further include a water-soluble organic solvent. Such water-soluble organic solvents are principally classified into humectants, which each have an effect of preventing the ink from being dried at a tip end portion of the ink-jet head, and penetrants, which accelerate a drying speed of the ink on a paper surface.

Examples of humectants include, but are not limited to, lower alcohols such as methyl alcohol, ethyl alcohol, n-propyl alcohol, isopropyl alcohol, n-butyl alcohol, sec-butyl alcohol, tert-butyl alcohol and the like; amides such as dimethylformamide, dimethylacetamide and the like; ketones or keto-alcohols such as acetone, diacetone alcohol and the like; ethers such as tetrahydrofuran, dioxane and the like; polyalkylene glycols such as polyethylene glycol, polypropylene glycol and the like; alkylene glycols such as ethylene glycol, propylene glycol, butylene glycol, diethylene glycol, triethylene glycol, dipropylene glycol, tripropylene glycol, thiodiglycol, hexylene glycol and the like; glycerin; 2-pyrrolidone; N-methyl-2-pyrrolidone; 1,3-dimethyl-2-imidazolidinone; and the like; and combinations thereof. Polyvalent alcohols such as alkylene glycols, glycerin and the like, are often used.

The amount of humectant in the ink is usually from 0 wt % to about 95 wt %, often from about 10 wt % to about 80 wt %, and more often from about 10 wt % to about 50 wt %, based on the total weight of the ink.

Examples of penetrants include, but are not limited to, ethylene glycol type ethers such as ethylene glycol methyl ether, ethylene glycol ethyl ether, ethylene glycol propyl ether, ethylene glycol butyl ether, diethylene glycol methyl ether, diethylene glycol ethyl ether, diethylene glycol propyl ether, diethylene glycol butyl ether, triethylene glycol methyl ether, triethylene glycol ethyl ether, triethylene glycol propyl ether, triethylene glycol butyl ether, propylene glycol methyl ether, and the like; propylene glycol type ethers such as propylene glycol ethyl ether, propylene glycol propyl ether, propylene glycol butyl ether, dipropylene glycol methyl ether, dipropylene glycol ethyl ether, dipropylene glycol propyl ether, dipropylene glycol butyl ether, tripropylene glycol methyl ether, tripropylene glycol ethyl ether, tripropylene glycol propyl ether, tripropylene glycol butyl ether, and the like; and combinations thereof.

The amount of penetrant in the ink is usually from 0 wt % to about 20 wt %, often from about 0.1 wt % to about 15 wt %, and more often from about 0.5 wt % to about 10 wt %, based on the total weight of the ink. When the amount is excessive, penetrability of the ink into recording paper may become unduly high and blurring may sometimes occur.

The ink also may include known additives, such as various types of surfactants, viscosity-adjusting agents, surface tension modifiers, pH modifiers, preservatives, mildewproofing agents, and the like.

The ink may be prepared by uniformly mixing the coloring agent containing the divalent metal in the structure thereof, the benzotriazole type compound, the polymer containing the polymerization unit having at least two carboxyl groups in the ethylene chain unit, water, and various types of additives as needed, in accordance with conventional techniques.

The ink as described above may be filled in a known ink-jet cartridge which may be detachably attached to an ink-jet recording apparatus of known configuration. The ink-jet recording apparatus typically has an ink-jet head having an ink discharge portion which communicates with the cartridge. Even when the ink ejection portion contains a metal member, e.g., made of nickel or the nickel-containing alloy, generation of rust may be suppressed. Even though a coloring agent containing a divalent metal in the structure thereof and a benzotriazole type compound are contained in the ink, generation of a precipitate by the reaction between the divalent metal and the benzotriazole type compound may be minimized or prevented. As a result, the apparatus provides excellent ink ejection stability.

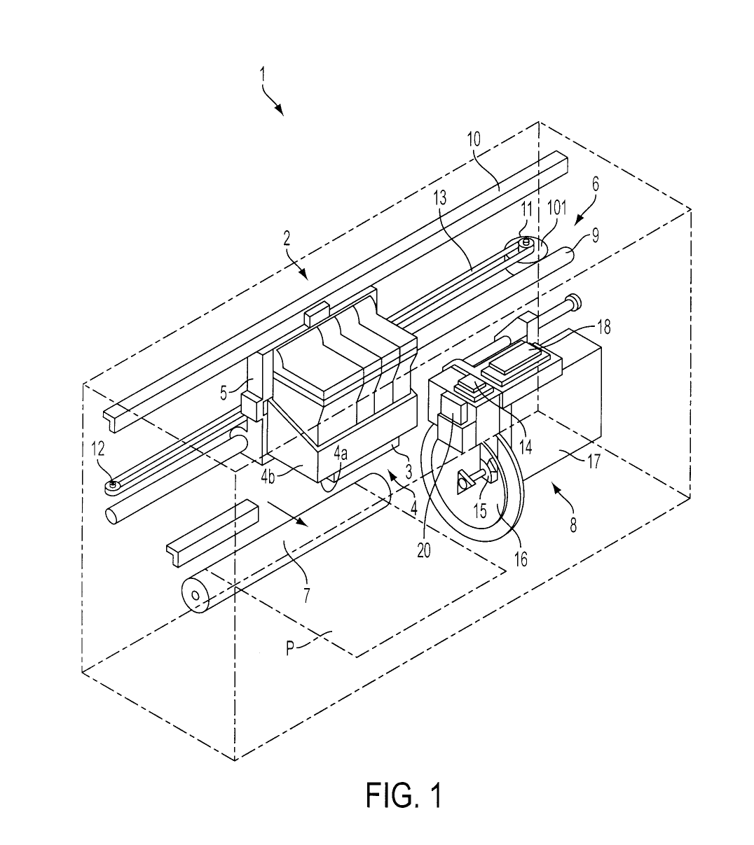

A schematic perspective view of a configuration of an ink-jet recording apparatus according to aspects of the invention is shown in FIG. 1.

This ink-jet recording apparatus 1 includes ink cartridges 2 which contain 4 color inks, typically cyan, magenta, yellow and black inks, respectively, a head unit 4 having an ink-jet head 3 for performing print on a recording medium P such as recording paper, a carriage 5 on which the ink cartridges 2 and the head unit 4 are mounted, a drive unit 6 that reciprocates the carriage 5 in a straight line direction, a platen roller 7 that extends in a reciprocating direction of the carriage 5 and is disposed opposite to the ink-jet head 3, and a purge unit 8.

The four filled ink cartridges 2 are arranged on a placing portion 4a of the head unit 4 between a pair of side covers 4b formed at both sides of the placing portion 4a.

The drive unit 6 includes a carriage shaft 9 that is disposed at a lower end portion of the carriage 5 and extends in parallel with the platen roller 7, a guide plate 10 that is disposed at an upper end portion of the carriage 5 and extends in parallel with the carriage shaft 9, two pulleys 11 and 12 that are disposed at both end portions of the carriage shaft 9 and between the carriage shaft 9 and the guide plate 10, and an endless belt 13 that is stretched between the pulleys 11 and 12.

As the pulley 11 out of the two is rotated in normal and reverse directions by a carriage motor 101, the carriage 5 that is connected to the endless belt 13 is reciprocated in the straight line direction, along the carriage shaft 9 and the guide plate 10, in accordance with the normal and reverse rotation of the pulley 11.

The recording medium P is supplied from a sheet supply cassette (not shown) provided on a side of or under the ink-jet recording apparatus 1, fed between the ink-jet head 3 and the platen roller 7, subjected to predetermined printing by the ink ejected from the ink-jet head 3, and then discharged to the outside. A sheet feeding mechanism and a sheet discharging mechanism of the recording medium P are omitted from FIG. 1.

The purge unit 8 is provided on a side of the platen roller 7. The purge unit 8 is disposed such that it is opposed to the ink-jet head 3 when the head unit 4 is placed in a reset position. The purge unit 8 includes a purge cap 14 that covers with opening portions of nozzles such that it covers a plurality of nozzles (not shown) formed in the ink-jet head 3, a pump 15, a cam 16, and an ink reservoir 17. When the head unit 4 is placed in the reset position, the nozzles in the ink-jet head 3 are covered with the purge cap 14 to suck defect ink, containing air bubbles trapped inside the ink-jet head 3, by the pump 15 driven by the cam 16, to thereby aim for recovering the ink-jet head 3. The sucked defect ink is stored in the ink reservoir 17.

A wiper member 20 is provided adjacent to the purge unit 8 in a position at the side of the platen roller 7 in the purge unit 8. The wiper member 20 is shaped in a spatula and wipes a nozzle-formed face of the ink-jet head 3 along the displacement of the carriage 5. In order to prevent the ink from being dried, the cap 18 is provided to cover a plurality of nozzles in the ink-jet head 3 which returns to the reset position after printing.

### EXAMPLES 1 TO 12 AND COMPARATIVE EXAMPLES 1 TO 6

Hereinafter, the present invention will be described in detail with reference to examples of water-based ink for ink-jet recording. However, these examples are illustrative and should not be interpreted as limiting the invention in any way.

(a) Preparation of Water-Based Ink for Ink-Jet Recording

Components of ink compositions in Table 1 were mixed and stirred. The resultant mixture was allowed to pass through a hydrophilic PTFE (polytetrafluoroethylene) type membrane filter (produced by Toyo Roshi Kaisha, Ltd.) having a pore diameter of 0.2 μm (except a pore diameter of 1.0 μm was used for Example 12), to thereby obtain water-based inks for ink-jet recording. Each of the inks in examples 1 to 12 contains a polymer containing a polymerization unit having at least two carboxyl groups in an ethylene chain unit thereof. The inks in Comparative Examples 1 to 6 do not contain such a polymer.

Dyes (1) to (5) used in Examples and Comparative Examples correspond to compounds to chemical formulas (1) to (5), respectively.

(b) Ink Ejection Performance Test

The thus-obtained water-based inks for ink-jet recording were filled in desired cartridges, and then the ink cartridges thus filled with the inks were attached to a digital multifunction device equipped with an ink-jet printer DCP-110 (produced by Brother Industries, Ltd.). The inks were then subjected to a 300-sheet continuous printing test, and thereafter the number of pins showing any dropout, or any ejection curvature were measured. The test result was evaluated in accordance with the criteria as described below and the obtained results are shown in Table 1. As a practical matter, an evaluation “A” or “B” is needed for commercial feasibility.
A: no pin showing the dropout or the ejection curvature
B: from 1 to 5 pins showing the dropout or the ejection curvature
C: from 6 to 10 pins showing the dropout or the ejection curvature
D: 11 or more pins showing the dropout or the ejection curvature

(c) Filtration Evaluation Test

120 g of the thus-obtained inks were subjected to an accelerated test for 2 weeks at 60° C. in a sealed condition, and then allowed to pass through a hydrophilic PTFE (polytetrafluoroethylene) type membrane filter (produced by Toyo Roshi Kaisha, Ltd.) having a diameter of 47 mm and a pore diameter of 0.2 μm (except a pore diameter of 1.0 μm was used for Example 12) under a reduced pressure. Thereafter, the weight of the ink passed through the membrane filter was measured and evaluated in accordance with the criteria as described below. The obtained results are shown in Table 1. As a practical matter, an evaluation “A” or “B” is needed for commercial feasibility.
A: 100 g or more of ink passed through the membrane filter
B: from 80 g to less than 100 g of ink passed through the membrane filter
C: from 50 g to less than 80 g of ink passed through the membrane filter
D: less than 50 g of ink passed through the membrane filter

(d) Anodic Polarization Measurement

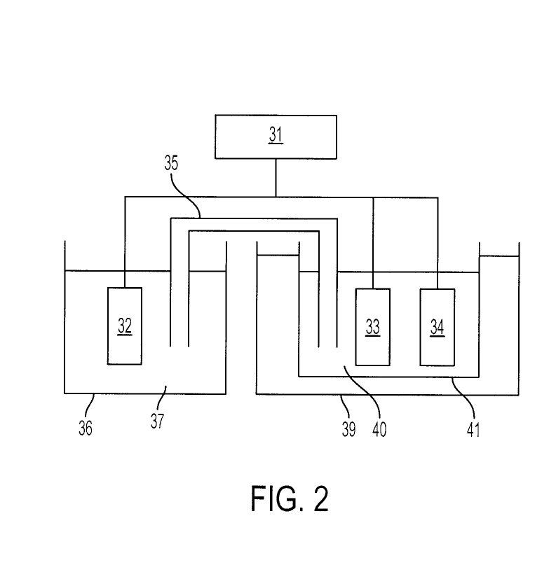

In an electrochemical measuring system HZ-3000 (produced by Hokuto Denko Corporation), an anodic polarization measurement was performed by a configuration shown in FIG. 2, which used an electrode as shown in Table 2. An iron-nickel alloy as shown in Table 2 denotes a nickel-iron alloy containing 42% nickel, namely, a so-called 42 alloy.

A method for the anodic polarization measurement was used as follows: (1) an ink 40 was introduced into a beaker 41, and the beaker 41 was immersed for 30 to 60 minutes in a thermostatic bath 39 set to a temperature of 60° C. such that the temperature of the ink 40 was allowed to be 60° C.; (2) a metal piece, which was used for a working electrode 33, was immersed for 5 minutes in an alkaline washing solution ACE CLEAN 850 (produced by Okuno Chemical Industries Co., Ltd.) at 60° C., and then the metal piece was washed with purified water; (3) the metal piece to be used as the working electrode 33 and a platinum plate to be used as a counter electrode 34, which were electrically connected to a main apparatus body 31, were immersed in the ink 40 introduced into the beaker 41; (4) a silver/silver chloride plate to be used as the reference electrode 32, which was electrically connected to the main apparatus body 31, was immersed in the saturated potassium chloride solution 37 introduced into the reference electrode bath 36 connected to the ink 40 introduced into the beaker 41 by the potassium chloride salt bridge 35; and (5) the electric potential is continuously changed within an electric potential range of from −600 to +300 mV to measure a current density.

Measurement results were evaluated in accordance with criteria as described below. The obtained results are shown in Table 1. As a practical matter, an evaluation “A” is needed for commercial feasibility.
A: current density in the electric potential range from −600 to +300 mV is 100 μA/cm² or less
C: current density in the electric potential range from −600 to +300 mV is more than 100 μA/cm²

TABLE 1

| | | | Example | | | | | | | | |
|---|---|---|---|---|---|---|---|---|---|---|---|
| | | | 1 | 2 | 3 | 4 | 5 | 6 | 7 | 8 | 9 |
| Ink composition | Dye (1) | | 2.0 | — | — | — | — | — | — | — | — |
| (wt %) | Dye (2) | | — | 3.0 | — | — | — | — | — | — | — |
| | Dye (3) | | — | — | 3.5 | — | — | — | — | — | — |
| | Dye (4) | | — | — | — | 4.0 | — | — | — | — | — |
| | Dye (5) | | — | — | — | — | 3.0 | — | — | — | — |
| | C.I. Direct Blue 199 | | — | — | — | — | — | 3.0 | 3.0 | 3.0 | 3.0 |
| | C.I. Direct Blue 86 | | — | — | — | — | — | — | — | — | — |
| | C.I. Reactive Red 23 | | — | — | — | — | — | — | — | — | — |
| | C.I. Pigment Blue | | — | — | — | — | — | — | — | — | — |
| | 15:3 | | | | | | | | | | |
| | Sodium | | 0.5 | 0.5 | 0.5 | 0.5 | 0.5 | 0.05 | 0.1 | 4.0 | 5.0 |
| | polyitaconate | | | | | | | | | | |
| | 1,2,3-benzotriazole | | 0.1 | 0.1 | 0.1 | 0.3 | 0.1 | 0.1 | 0.1 | 0.1 | 0.1 |
| | 85% aqueous | | 27.0 | 27.0 | 27.0 | 27.0 | 27.0 | 27.0 | 27.0 | 27.0 | 27.0 |
| | glycerin solution | | | | | | | | | | |
| | Diethylene glycol | | 6.0 | 6.0 | 6.0 | 6.0 | 6.0 | 6.0 | 6.0 | 6.0 | 6.0 |
| | Triethylene glycol | | 3.0 | 3.0 | 3.0 | 3.0 | 3.0 | 3.0 | 3.0 | 3.0 | 3.0 |
| | butyl ether | | | | | | | | | | |
| | Proxel GXL(S)*¹ | | 0.2 | 0.2 | 0.2 | 0.2 | 0.2 | 0.2 | 0.2 | 0.2 | 0.2 |
| | Purified water | | Bal. | Bal. | Bal. | Bal. | Bal. | Bal. | Bal. | Bal. | Bal. |
| Evaluation | Ink ejection | | A | A | A | B | A | B | A | A | B |
| | performance test | | | | | | | | | | |
| | Filtration evaluation | | A | A | A | B | A | B | A | A | A |
| | test | | | | | | | | | | |
| | Anodic | Iron-nickel | A | A | A | A | A | A | A | A | A |
| | polarization | alloy | | | | | | | | | |
| | test | Nickel | A | A | A | A | A | A | A | A | A |
| | | | Example | | | Comparative Example | | | | | |
| | | | 10 | 11 | 12 | 1 | 2 | 3 | 4 | 5 | 6 |
| Ink composition | Dye (1) | | — | — | — | 2.0 | — | — | — | — | — |
| (wt %) | Dye (2) | | — | — | — | — | 3.0 | — | — | — | — |
| | Dye (3) | | — | — | — | — | — | 3.5 | — | — | — |
| | Dye (4) | | — | — | — | — | — | — | 4.0 | — | — |
| | Dye (5) | | — | — | — | — | — | — | — | 3.0 | — |
| | C.I. Direct Blue 199 | | — | — | — | — | — | — | — | — | 3.0 |
| | C.I. Direct Blue 86 | | 3.0 | — | — | — | — | — | — | — | — |
| | C.I. Reactive Red 23 | | — | 2.0 | — | — | — | — | — | — | — |
| | C.I. Pigment Blue | | — | — | 2.0 | — | — | — | — | — | — |
| | 15:3 | | | | | | | | | | |
| | Sodium | | 4.0 | 1.0 | 1.0 | — | — | — | — | — | — |
| | polyitaconate | | | | | | | | | | |
| | 1,2,3-benzotriazole | | 0.1 | 0.1 | 0.1 | 0.1 | 0.1 | 0.1 | 0.3 | 0.1 | — |
| | 85% aqueous | | 27.0 | 27.0 | 25.0 | 27.0 | 27.0 | 27.0 | 27.0 | 27.0 | 27.0 |
| | glycerin solution | | | | | | | | | | |
| | Diethylene glycol | | 6.0 | 6.0 | 6.0 | 6.0 | 6.0 | 6.0 | 6.0 | 6.0 | 6.0 |
| | Triethylene glycol | | 3.0 | 3.0 | 3.0 | 3.0 | 3.0 | 3.0 | 3.0 | 3.0 | 3.0 |
| | butyl ether | | | | | | | | | | |
| | Proxel GXL(S)*¹ | | 0.2 | 0.2 | 0.2 | 0.2 | 0.2 | 0.2 | 0.2 | 0.2 | 0.2 |
| | Purified water | | Bal. | Bal. | Bal. | Bal. | Bal. | Bal. | Bal. | Bal. | Bal. |
| Evaluation | Ink ejection | | A | A | A | C | C | C | D | C | C |
| | performance test | | | | | | | | | | |
| | Filtration evaluation | | A | A | A | C | C | C | D | C | A |
| | test | | | | | | | | | | |
| | Anodic | Iron-nickel | A | A | A | A | A | A | A | A | C |
| | polarization | alloy | | | | | | | | | |
| | test | Nickel | A | A | A | A | A | A | A | A | C |

*¹Aqueous dipropylene glycol solution containing 1,2-benzisothiazolin-3-one (20 wt %) produced by Arch Chemicals Japan, Inc.

TABLE 2

| | | | | Size |
|---|---|---|---|---|
| | | | | L(mm) × |
| Electrode | Type | Name | Maker | W(mm) × T(mm) |
| Reference | Silver/silver | Reference | DKK-TOA | — |
| electrode | chloride | electrode | Corp. | |
| | | HS-205C | | |
| Counter | Platinum | Pure | Tanaka | 40 × 20 × 0.1 |
| electrode | | platinum | Kikinzoku | |
| | | plate | Kogyo K.K. | |
| Working | Iron-nickel | 42 alloy | Yamaha | 40 × 10 × 0.1 |
| electrode | alloy | | Metanics | |
| | | | Corporation | |
| | Nickel | Pure nickel | — | 40 × 10 × 0.1 |
| | | (Ni) for | | |
| | | industrial | | |
| | | use | | |

As evident from Table 1, the ink in each of Examples 1 to 12 provided excellent ink ejection performance results (the number of pins showing any dropout or any ejection curvature was small) compared with the inks of Comparative Examples 1 to 6. The inks of each of Examples 1 to 12 also were excellent in the filtration evaluation test result (the quantity of each of the water-based inks which have passed through the membrane filter was large), and further excellent in the anodic polarization evaluation result (the current density at the time the electric potential was continuously changed within an electric potential range of from −600 to +300 mV was low).

The invention is not limited to the embodiments described in the Examples, which are provided for illustrative purposes only. It will be apparent that various modifications can be made without departing from the spirit and the scope of the invention as described and claimed herein.

What is claimed is:

1. A water-based ink for ink-jet recording comprising:
a coloring agent comprising a divalent metal in a structure thereof;
a benzotriazole type compound; and
a polymer comprising a polymerization unit having at least two carboxyl groups in an ethylene chain unit.

2. The water-based ink according to claim 1, wherein the coloring agent is a dye.

3. The water-based ink according to claim 1, wherein the coloring agent is a copper complex dye.

4. The water-based ink according to claim 1, wherein the coloring agent is a copper phthalocyanine type dye.

5. The water-based ink according to claim 1, wherein the polymer is sodium polyitaconate.

6. The water-based ink according to claim 1, wherein the polymer is present in an amount from about 0.05 wt % to about 5 wt %, based on the total weight of the water-based ink.

7. The water-based ink according to claim 1, further comprising an organic solvent selected from the group consisting of lower alcohols, amides, ketones, keto alcohols, ethers, polyalkylene glycols, alkylene glycols, and combinations thereof.

8. The water-based ink according to claim 7, wherein the organic solvent is selected from the group consisting of methyl alcohol, ethyl alcohol, n-propyl alcohol, isopropyl alcohol, n-butyl alcohol, sec-butyl alcohol, tert-butyl alcohol, dimethylformamide, dimethylacetamide, acetone, diacetone alcohol, tetrahydrofuran, dioxane, polyethylene glycol, polypropylene glycol, ethylene glycol, propylene glycol, butylene glycol, diethylene glycol, triethylene glycol, dipropylene glycol, tripropylene glycol, thiodiglycol, hexylene glycol, and combinations thereof.

9. The water-based ink according to claim 1, further comprising an organic solvent is selected from the group consisting of ethylene glycol based ethers, propylene glycol based ethers, and combinations thereof.

10. The water-based ink according to claim 1, further comprising an organic solvent is selected from the group consisting of glycerin, 2-pyrrolidone, N-methyl-2-pyrrolidone, 1,3-dimethyl-2-imidazolidinone, and combinations thereof.

11. An ink-jet recording apparatus comprising:
an ink cartridge filled with a water-based ink for ink-jet recording comprising a coloring agent having a divalent metal in a structure thereof, a benzotriazole type compound, and a polymer comprising a polymerization unit having at least two carboxyl groups in an ethylene chain unit; and
an ink-jet head comprising an ink ejection portion which communicates with the ink cartridge, wherein the ink ejection portion comprises a metal member comprising nickel or a nickel-containing alloy.

12. The ink-jet recording apparatus according to claim 11, wherein the coloring agent is a dye.

13. The ink-jet recording apparatus according to claim 11, wherein the coloring agent is a copper complex dye.

14. The ink-jet recording apparatus according to claim 11, wherein the polymer is sodium polyitaconate.

15. The ink-jet recording apparatus according to claim 11, wherein the polymer is present in an amount from about 0.05 wt % to about 5 wt %, based on the total weight of the water-based ink.

16. A method of suppressing generation of a precipitate in a water-based ink for ink-jet recording, wherein the water-based ink comprises a coloring agent having a divalent metal in a structure and thereof and a benzotriazole type compound, the method comprising adding to the ink a polymer having a polymerization unit comprising at least two carboxyl groups in an ethylene chain unit.

17. The method according to claim 16, wherein the coloring agent is a dye.

18. The method according to claim 16, wherein the coloring agent is a copper complex dye.

19. The method according to claim 16, wherein the polymer is sodium polyitaconate.

20. The method according to claim 16, wherein the polymer is added to the water-based ink in an amount from about 0.05 wt % to about 5 wt %, based on the total weight of the water-based ink.
